(19) United States
(12) Patent Application Publication
(10) Pub. No.: US 2010/0212470 A1
(43) Pub. Date: Aug. 26, 2010

(54) DISKLIKE CUTTING TOOL AND CUTTING DEVICE

(76) Inventor: Kazumasa Ohnishi, Niigata (JP)

Correspondence Address: NIXON PEABODY, LLP, 401 9TH STREET, NW, SUITE 900, WASHINGTON, DC, 20004-2128, US

(21) Appl. No.: 12/445,988

(22) PCT Filed: Oct. 16, 2007
(86) PCT No.: PCT/JP2007/070162

§ 371 Date: Apr. 17, 2009

(30) Foreign Application Priority Data
Oct. 17, 2006 (JP) 2006-308423
Jan. 4, 2007 (JP) 2007-023521
Mar. 13, 2007 (JP) 2007-103282

(51) Int. Cl. B23D 47/00; B23D 61/00

(52) U.S. Cl. 83/646; 83/698.41; 83/676

(57) ABSTRACT

A disklike cutting tool (10) comprises a disklike cutting blade (12) having a circular hole (11) in the center, an annular supporting plate (19) arranged on the surface on each side of the blade (12) coaxially therewith and supporting/fixing the blade (12) at a position on the inner circumferential side of the outer circumferential edge of the blade, and a continuous annular ultrasonic vibrator (14) secured to the surface of the supporting plate (19) coaxially with the blade at a position on the outer circumferential side of the inner circumferential edge of the supporting plate (19). The supporting plate (19) has an ultrasonic reflection plane (16) consisting of the interface with a continuous or discontinuous annular air phase space extending in the thickness direction of the supporting plate (19) at a position on the inner circumferential side of the inner circumferential edge of the ultrasonic vibrator (14). The outer circumferential edge of the blade (12) can perform ultrasonic vibration with a large amplitude in the radial direction of the blade.

### FIELD OF THE INVENTION

This invention relates to a cutting disc tool (i.e., cutting tool in the form of disc) and a cutting machine.

### BACKGROUND OF THE INVENTION

Heretofore, a cutting machine equipped with a cutting disc blade has been generally employed for cutting an article made of rigid and fragile material such as glass, silicon, silicon nitride, alumina-TiC (titanium carbide-containing alumina), rare earth magnetic material, or hard metal. In the cutting machine, the disc blade is rotated and brought into contact with the article at a cutting edge on the outer periphery, so as to cut (e.g., cut or groove) the article.

Patent Publication 1 (JP 2004-291636 A) discloses a cutting machine equipped with a cutting disc tool (disc blade) comprising a cutting disc blade (cutting blade) and an ultrasonic vibrator in the form of a ring fixed on a surface of the blade. When the cutting machine is operated, the cutting disc tool is rotated with the cutting blade while an ultrasonic wave generated in the ultrasonic vibrator is applied to the blade, and a cutting edge on the outer periphery of the blade vibrating in an ultrasonic mode is brought into contact with an article to be processed, whereby the article is cut. It is described that the cutting blade to which the ultrasonic vibration is applied is effective to cut an article with a high precision.

### SUMMARY OF THE INVENTION

When an ultrasonic vibration is applied to a cutting blade as is described in Patent Publication 1, it is desired that the ultrasonic vibration is applied to the blade so as to vibrate the cutting edge on the outer periphery of the blade in the radial direction with an enlarged amplitude. If the cutting edge is vibrated in the radial direction in an ultrasonic mode with an enlarged amplitude, the cutting resistance lowers so that generation of heat in the article and thermal expansion of the article decreases and hence the article is cut with a high precision.

It is an object of the invention to provide a cutting disc tool in which a cutting edge of the cutting blade can be vibrated in its radial direction in an ultrasonic mode with an enlarged amplitude and a cutting machine equipped with the cutting disc tool.

There is provided by the invention a cutting disc tool comprising a cutting disc blade having a circular hole at a center thereof, a support ring plate coaxially fixed onto at least one surface of the blade in an area inner than an outer periphery of the blade, and an ultrasonic vibrator in the form of a continuous or discontinuous ring, the ultrasonic vibrator being coaxially fixed onto a surface of the support plate or a surface of the blade in an area outer than an inner periphery of the support plate, wherein the support plate has an ultrasonic wave reflecting face extending in a thickness direction thereof, said reflecting face being an interface formed between the support plate and a continuous or discontinuous circular vacant space formed on the support plate in an area inner than an inner periphery of the ultrasonic vibrator.

The above-described invention is referred to as a first invention.

Preferred embodiments of the cutting tool according to the first invention are described below.

(1) The circular vacant space comprises plural arcuate vacant spaces connected sequentially via a non-vacant area, said vacant spaces being formed coaxially on the support plate and extending in a thickness direction of the support. More preferably, other arcuate vacant spaces are formed on the support along the non-vacant area on an inner periphery side of the support plate, said vacant spaces extending a thickness direction of the support plate, whereby forming an additional ultrasonic wave reflecting face.

(2) The circular vacant space comprises plural circular or polygonal vacant spaces connected sequentially via a non-vacant area, said vacant spaces being formed coaxially on the support plate and extending in a thickness direction of the support. More preferably, other circular or polygonal vacant spaces are formed on the support along the non-vacant areas on an inner periphery side of the support plate, said vacant spaces extending a thickness direction of the support plate, whereby forming an additional ultrasonic wave reflecting face.

(3) The circular vacant space comprises plural vacant slits connected sequentially via non-vacant areas, said vacant slits being formed around an center axis of the support plate, slanting to a radial direction of the support plate, and extending in a thickness direction of the support.

(4) The circular vacant space is formed of circular porous material.

(5) The support has the ultrasonic wave reflecting face formed on a wall of a circular groove extending from one surface thereof exceeding a half of a thickness of the support plate and an additional ultrasonic wave reflecting face formed on a wall of a circular groove extending from another surface thereof exceeding a half of a thickness of the support.

(6) The ultrasonic vibrator comprises plural ultrasonic vibrator pieces arranged sequentially via a space and a vacant space is formed in the support plate under the former space.

There is further provided a cutting machine comprising:

a cutting disc tool comprising a cutting disc blade having a circular hole at a center thereof, a support ring plate coaxially fixed onto at least one surface of the blade in an area inner than an outer periphery of the blade, and an ultrasonic vibrator in the form of a continuous or discontinuous ring, the ultrasonic vibrator being coaxially fixed onto a surface of the support plate or a surface of the blade in a area outer than an inner periphery of the support plate, wherein the support plate has ultrasonic wave reflecting face extending in a thickness direction thereof, said reflecting face being interface formed between the support plate and a continuous or discontinuous circular vacant space formed on the support plate in an area inner than an inner periphery of the ultrasonic vibrator, and

a rotating shaft holding the cutting disc tool in a position inner than the ultrasonic wave reflecting face of the support plate.

Preferred embodiments of the cutting tool employed in the above-mentioned cutting machine are the same as those described for the first invention.

Further, there is provided by the invention a cutting disc tool comprising a cutting disc blade having a circular hole at a center thereof, a pair of support ring plates coaxially arranged in parallel to the blade with spaces, said support ring plates each having a protruded ring which holds the blade in an area inner than an outer periphery of the blade, and an ultrasonic vibrator in the form of a continuous or discontinuous ring, the ultrasonic vibrator being coaxially fixed onto a surface of the support plate in an area outer than an inner periphery of the support plate or onto a surface of the blade in an area outer than the protruded ring of the support plate, wherein the support plate has an ultrasonic wave reflecting face extending in a thickness direction thereof, said reflecting face being an interface formed between the support plate and a continuous or discontinuous circular vacant space formed on the support plate in an area inner than an inner periphery of the ultrasonic vibrator.

The above-described invention is referred to as a second invention.

Preferred embodiments of the cutting tool according to the second invention are the same as those described for the cutting tool according to the first invention.

There is furthermore provided a cutting machine comprising:

a cutting disc tool comprising a cutting disc blade having a circular hole at a center thereof, a pair of support ring plates coaxially arranged in parallel to the blade with spaces, said support ring plates each having a protruded ring which holds the blade in an area inner than an outer periphery of the blade, and an ultrasonic vibrator in the form of a continuous or discontinuous ring, the ultrasonic vibrator being coaxially fixed onto a surface of the support plate in an area outer than an inner periphery of the support plate or onto a surface of the blade in an area outer than the protruded ring of the support plate, wherein the support plate has an ultrasonic wave reflecting face extending in a thickness direction thereof, said reflecting face being an interface formed between the support plate and a continuous or discontinuous circular vacant space formed on the support plate in an area inner than an inner periphery of the ultrasonic vibrator, and

a rotating shaft holding the cutting disc tool in a position inner than the ultrasonic wave reflecting face of the support plate.

Preferred embodiments of the cutting tool employed in the above-mentioned cutting machine are the same as those described for the first invention.

In the specification, the description of “in a thickness direction of the support” is meant to include “directions at an angle within 20°, preferably within 10°, to the direction perpendicular to the surface of the support.

The cutting disc tools and cutting machines according to the invention enable to vibrate the cutting edge of the blade in the radial direction in an ultrasonic mode with an enlarged amplitude and hence can cut articles with high precision.

### DETAILED DESCRIPTION OF THE INVENTION

The cutting tool of the first invention and the cutting machine equipped with the cutting tool are described with reference to the attached drawings.

FIG. 1 is a top view of an example of the cutting tool according to the invention, and FIG. 2 is a sectional view of the cutting tool 10, taken along the line I-I shown in FIG. 1.

The cutting tool 10 shown in FIGS. 1 and 2 comprises a cutting disc blade 12 having a circular hole 11 at its center, a support ring plate 19 coaxially fixed onto each surface of the blade 12 in an area inner than an outer periphery of the blade 12, and an ultrasonic vibrator 14 in the form of a continuous ring, in which the ultrasonic vibrator 14 is coaxially fixed onto a surface of the support plate 19 in an area outer than an inner periphery of the support plate 19. Each support plate 19 has an ultrasonic wave reflecting face 16 extending in its thickness direction, in which the reflecting face 16 is an interface formed between the support 19 and a discontinuous circular vacant space (composed vacant spaces of four arcuate openings 15, 15, 15, 15) formed on the support 19 in an area inner than an inner periphery of the ultrasonic vibrator 14.

The cutting blade 12 can be a known cutting disc blade such as a circular saw, a cutting blade in the form of a disc comprising a disc substrate having abrasive grains fixed thereonto in an area in the vicinity of the outer periphery, or a resinoid blade prepared by subjecting a composition of a resin (binder) and abrasive grains to heat processing. The substrate of the cutting blade can be made of metallic material such as aluminum, titanium, iron, aluminum alloy or stainless steel.

The abrasive grains can be diamond grains, alumina grains, silica grains, iron oxide grains, chromium oxide grains, silicon carbide grains or cubic boron nitride (CBN) grains. The grain size is generally in the range of 0.1 to 50 μm. The abrasive grains can be fixed (plated) onto a disc substrate in the vicinity of the outer periphery in a plating bath containing abrasive grains by electroplating. Otherwise, the abrasive grains can be fixed onto the substrate using a binder resin (e.g., phenol-formalin resin).

In the cutting tool 10 shown in FIGS. 1 and 2, a support plate 19 in the form of a ring is fixed onto each surface of the cutting blade 12 coaxially with the axis of the blade 12. Each support plate 19 supports the cutting blade 12 in an area inner than the outer periphery of the blade.

The support plate 19 can be made of metallic material such as aluminum, titanium, iron, aluminum alloy, titanium alloy or stainless steel.

The support plate 19 can be easily manufactured by forming four arcuate openings 15, 15, 15, 15 on a circular plate to give an ultrasonic wave reflecting face 16. The arcuate opening 15 can be formed on the support plate by means of a cutting procedure or a laser processing method.

In the cutting tool 10 shown in FIGS. 1 and 2, each continuous ultrasonic vibrator is coaxially fixed onto each support plate in an area outer than the inner periphery of the support plate 19. Thus, the inner diameter of the ultrasonic vibrator ring 14 is larger than the inner diameter of the support plate 19.

The ultrasonic vibrator 14 in the form of a ring can be a piezoelectric vibrator composed of a piezoelectric ring plate and a pair of electrodes placed on each surface of the ring plate. The piezoelectric vibrator can generate a ultrasonic wave when an electric energy (e.g., AC voltage) is applied to each electrode.

The piezoelectric plate of the ultrasonic vibrator (piezoelectric vibrator) 14 is polarized in its thickness direction toward the blade 12. The piezoelectric plate can be made of piezoelectric ceramic material such as lead zirconate-lead titanate (PZT) or piezoelectric polymer material such as poly(vinyl fluoride) resin. The electrode can be made of metallic material such as silver or bronze.

The ultrasonic vibrator 14 can be fixed onto a surface of the support plate 19 using a known adhesive such as epoxy resin. The adhesive can be an electroconductive or insulating adhesive. If an electroconductive adhesive is employed, the electrode placed on the blade side can easily receive an electric energy through the support plate 19.

The cutting tool 10 can be held around a rotating shaft of a motor, in the manner described in the aforementioned Patent Publication 1. In more detail, the motor is driven to rotate the rotating shaft holding the cutting tool 10. Subsequently, an electric energy is supplied to the ultrasonic vibrator 14, 14 of the cutting tool 10, whereby each ultrasonic vibrator generates an ultrasonic wave vibrating in its radial direction. The ultrasonic wave is then applied to each support plate 19, whereby the support plate 19 vibrate in its radial direction. Since the cutting blade 12 is fixed to each support plate 19, the blade 12 vibrates in its radial direction together with each support plate 19. Thus, the cutting blade 12 vibrates in a radial direction repeatedly in such manner of displacement that the diameter of the blade alternately expands and shrinks. The cutting edge on the outer periphery of the rotating blade showing the above-mentioned ultrasonic vibration is brought into contact with an article to be processed, to wholly or partly cut (i.e., cut or groove) the article.

The cutting tool 10 shown in FIGS. 1 and 2, each support plate 19 supporting the cutting blade 12 has an ultrasonic wave reflecting face 16 in an area inner than the inner periphery of the ultrasonic vibrator 14. The ultrasonic wave reflecting face 16 is formed on walls facing discontinuous vacant spaces (spaces in four arcuate openings 15, 15, 15, 15) which extend in the thickness direction of the support plate 19.

It is generally known that transmission of an acoustic wave from one material to other material having a distinctly differing intrinsic acoustic impedance through an interface between their materials is disturbed, because most of the acoustic wave is reflected on the interface. The acoustic impedance is defined by a value obtained by multiplication of density of the material and acoustic velocity in the material. In the case that the interface is formed between solid material and gaseous phase, most of an acoustic wave transmitting in the solid material is reflected on the interface between the solid material and the gaseous phase because the solid material having a high density shows an apparently higher impedance than the impedance of the gaseous phase having an extremely low density.

The four arcuate openings 15, 15, 15, 15 formed in each support plate (made of solid material) 19 of the cutting tool 10 enclose gaseous phases.

Thus, the interface between the material of the support plate 19 and the arcuate openings gives ultrasonic wave reflecting face 16. The ultrasonic wave which is transmitted from each of the ultrasonic vibrators 14, 14 to the support plate 19 in the cutting procedure and then transmitted on the support plate in the radial direction (which vibrates the support plate 19 in the radial direction) is reflected on the ultrasonic wave reflecting face 16 and is not transmitted to the area of the support plate inner than the reflecting face 16. The reflected ultrasonic wave is returned and transmitted toward the outer periphery of the supporting plate 19.

Therefore, the ultrasonic wave (energy of the ultrasonic wave) generated in each ultrasonic vibrator 14 is efficiently utilized to vibrate the portion of the support plate 19 outer than the reflecting face 16, and hence the support plate 19 vibrates in the radial direction with an enlarged amplitude in the area on the outer periphery side. The cutting blade 12 fixed onto the each support plate 19 vibrates in its radial direction with an enlarged amplitude simultaneously with the supporting plates.

For the reason mentioned above, the cutting edge of the blade of the cutting tool according to the invention which vibrates in the radial direction with an enlarged amplitude is brought into contact with an article at decreased resistance during the cutting procedure. Therefore, generation of heat in the article and thermal expansion of the article caused by friction with the cutting blade are reduced, and the cutting procedure can be performed with a high precision.

For example, the cutting edge of the blade 12 of the cutting tool 10 can vibrate with such a large amplitude as 5 μm or more in the radial direction even when the ultrasonic vibrator 14 receives an AC voltage lower than 100 V, depending on the size (such as thickness) of the cutting blade 12. In contrast, a cutting edge of a blade of a cutting tool 10 having an ultrasonic vibrator directly fixed onto the blade, that is, without the aforementioned surface plate having the ultrasonic wave reflecting face, vibrates with such a small amplitude of one tenth or less than the amplitude provided by the cutting tool of the invention.

The ultrasonic wave reflecting face 16 is an interface extending essentially in a thickness direction, that is, a direction perpendicular to the surface of the support plate 19 which is in contact with the vacant space in the form of a ring. Therefore, the ultrasonic wave generated in the ultrasonic vibrator 14 and transmitted on the support plate in the radial direction is reflected on the reflecting face perpendicularly and then transmitted in the support plate 19 toward the outer periphery of the support plate 19 in parallel with the surface of the support plate. Accordingly, there is produced no unfavorable ultrasonic wave transmitting in the support plate 19 with an angle.

If the ultrasonic wave reflecting face is formed at a large angle with a direction perpendicular to the surface of the support plate, the ultrasonic wave is reflecting on the slanting reflecting face and then transmitted in the support plate with an angle to the surface of the support plate. The ultrasonic wave transmitted with an angle to the surface of the support plate causes deflective vibration (vibration containing a mode vibrating in the thickness direction) in the support plate and cutting blade supported by the support plate. Therefore, the cutting edge of the blade vibrates in the thickness direction, and the article is cut with an enlarged cutting width. This means that the cutting precision lowers. Otherwise, the yield of articles manufactured by the cutting procedure decreases because a relatively large amount of the material is powdered by the cutting with a wide vibration in the thickness direction.

The cutting tool of the invention, for example the cutting tool shown in FIGS. 1 and 2 can vibrate the cutting blade 12 with an enlarged amplitude in the radial direction, as compared with a cutting tool equipped with no support plate having the ultrasonic wave reflecting face, regardless of the thickness of the blade 12.

Nevertheless, if the thickness of the cutting blade 12 increases, some of the ultrasonic wave generated in the ultrasonic vibrator 14, 14 may be transmitted to the rotating shaft holding the blade 12 through the support plate 19, 19 and the blade 12. Therefore, it is preferred that the cutting blade 12 has a small thickness such as 1 mm or less, preferably in the range of 5 to 500 μm, more preferably in the range of 5 to 100 μm. Thus, the cutting tool of the invention is employed specifically favorably for performing fine cutting procedures using a blade having a small thickness.

The cutting blade is easily distorted in the thickness direction if the blade has a smaller thickness. Therefore, a cutting blade having a smaller thickness may vibrate not only in the radial direction but also in the thickness direction when the blade receives the ultrasonic vibration or is vibrated during its rotation. The support plate 19 can reinforce the cutting blade having a small thickness so that the blade is kept from vibration in the thickness direction.

In order to sufficiently reinforce the cutting blade, the support plate 19 preferably has a thickness of 0.1 mm or more, more preferably 0.2 mm or more, but 20 mm or less.

In the cutting tool of the invention, the circular vacant space comprises plural arcuate vacant space symmetrically formed around the center axis of the support plate via a non-vacant bridging space.

For example, in the cutting tool 10 shown in FIGS. 1 and 2, the vacant space in the form of a ring comprises four arcuate openings 15, 15, 15, 15 which are symmetrically formed around the center axis of the support plate 19 via non-vacant bridging space 18. Therefore, the ultrasonic wave reflecting face 16 provided to the support plate 19 of the cutting tool 10 comprises four reflecting faces 17, 17, 17, 17 corresponding to the arcuate wall of the four arcuate openings. The openings traverse the support plate from one surface to another surface.

The support plate having the vacant space in the form of a ring comprising plural vacant spaces via a non-vacant bridging area 18 shows a sufficient strength, because the support plate in the area outer than the reflecting face 16 is sufficiently supported by the support plate in the area inner the reflecting face 16.

The support plate having plural arcuate vacant spaces (such as four arcuate vacant openings 15, 15, 15, 15) formed symmetrically around the center axis of the support plate 19 has its center of gravity at its center axis. Therefore, the cutting blade 10 can stably rotate with ultrasonic vibration with a high rotation precision even when the rotation is performed at such high rotation rate as several thousands or several ten thousands, whereby the cutting procedure can be made with a high precision.

If the plural openings traverse the support plate 19 from one surface to another surface, the support plate is distinctly separated at the ultrasonic wave reflecting face between the outer area and inner area. Therefore, the ultrasonic wave generated in the ultrasonic vibrator 14 hardly transmitted to the area inner than the reflecting 16 of the support plate 19 and further to the rotating shaft holding the cutting tool 10.

It is noted that the ultrasonic wave reflecting face corresponds to an outer interface when two or more interfaces are formed in the radial direction in the support plate of the cutting plate of the invention. For instance, if the support plate 19 has an outer interface 16 and an inner interface 16a formed around the vacant space in the form of a ring composed of four arcuate vacant openings 15, 15, 15, 15, the ultrasonic wave reflecting face should be understood to correspond to the outer interface 16.

The interface 16a reflects a small amount of the ultrasonic wave transmitted from the outer area of the support plate 19 through the vacant space to return the wave toward the outer area of the plate 19. Thus, the ultrasonic wave generated in the ultrasonic vibrator 14 is still not transmitted to the inner area of the plate 19 and further to the rotating shaft. If the ultrasonic wave generated in the ultrasonic vibrator 14 is transmitted to the rotating shaft, the bearing holding the rotating shaft likely decreases its endurance.

From another aspect, the interface 16a can reflect an outer vibration (noise) transmitted to the inner area of the plate 19 from the rotating shaft to return it to the inner area of the plate 19. Therefore, the interface 16a can serve to keep the outer area of the plate 19 from receiving the outer vibration. If the outer vibration is transmitted to the outer area of the plate 19, the cutting edge of the blade 12 fixed to the support plate 19 may vibrate in its thickness direction, and hence the cutting precision may lower.

FIG. 3 is a sectional view of a cutting machine of the invention which is equipped with the cutting tool 10 shown in FIGS. 1 and 2.

The cutting machine 30 of FIG. 3 comprises:

a cutting disc tool 10 comprising a cutting disc blade 12 having a circular hole 11 at a center thereof, a support ring plate 19 coaxially fixed onto at least one surface of the blade 12 in an area inner than an outer periphery of the blade 12, and an ultrasonic vibrator 14 in the form of a continuous or discontinuous ring, the ultrasonic vibrator 14 being coaxially fixed onto a surface of the support plate 19 or a surface of the blade 12 in a area outer than an inner periphery of the support plate 19, wherein the support plate 19 has an ultrasonic wave reflecting face 16 extending in a thickness direction thereof, said reflecting face 16 being interface formed between the support 19 and a continuous or discontinuous circular vacant space formed on the support 19 in an area inner than an inner periphery of the ultrasonic vibrator 14, and

a rotating shaft 32 holding the cutting disc tool 10 in a position inner than the ultrasonic wave reflecting face 16 of the support plate 19.

The rotating shaft 32 of the cutting machine 30 is equipped with holding means 33 for holding the cutting tool 10 therearound. The holding means 33 comprises a sleeve 36 and a flange 35. The sleeve 36 is equipped with a flange 34 having a protruded ring 34a on the side of the cutting tool 10 and is fixed around the rotating shaft 32 by means of a bolt 37. The flange 35 having a protruded ring 35a on the side of the cutting tool 10 is fixed around the sleeve 36 by means of a nut 38. The holding means 33 can be made of metallic material such as titanium or stainless steel.

As is shown in FIG. 3, the rotating shaft 32 of the cutting machine 30 holds the cutting tool 10 with a pair of the protruded rings 34a, 35a in an area inner than the ultrasonic wave reflecting face 16 of the plate 19.

The cutting machine is further equipped with a power source 21 and a rotary transformer 22. The rotary trans-former 22 comprises a power supply ring unit 23 equipped with a coil 23a which is coiled in a circular direction of the rotating shaft 32 and a power receiving ring unit 24 equipped with a similar coil 24a.

As is shown in FIG. 3, the power supply unit 23 can be fixed to the motor 31, being kept from contacting the rotating shaft 32. The power receiving unit 24 can be fixed to the sleeve 36 attached to the rotating shaft 32 of the motor 31.

The rotary transformer 22 enables to supply an electric energy (e.g., AC voltage) given to the coil 23a of the electric supply unit 23 to the coil 24a of the rotating power receiving unit 24. The rotary transformer 22 per se is described in the aforementioned Patent Publication 1 and known. Therefore, no further descriptions on the rotary transformer are required. The rotary trans-former 22 can be replaced with a slip ring.

When the electric energy (e.g., AC voltage) generated in the power source 21 is given to the coil 23a of the supply unit 23 through the electric wirings 25a, 25b, the energy is transmitted to the coil 24a of the receiving unit 24, and then transmitted to the ultrasonic vibrator 14 through the electric wirings 26a, 26b connected to the coil 24a, and the electric vibrator 14 generates an ultrasonic vibration. The electrode of the ultrasonic vibrator 14 on the side of the support plate 19 is electrically connected to the coil 24a of the receiving unit 24 via the wiring 26a, sleeve 36 and support plate 19.

The cutting procedure (including cutting procedure and grooving procedure) can be carried out using the cutting machine 30 in the below-described manner.

First, the motor 31 is driven to rotate the rotating shaft 32 holding the cutting tool 10. Subsequently, an electric energy generated in a power source 21 is transmitted to the ultrasonic vibrator 14 through the wirings 25a, 25b, rotary transformer 22, and wirings 26a, 26b. The ultrasonic vibrator 14 then generates ultrasonic vibration which vibrates in the radial direction of the vibrator 14. The ultrasonic vibration is given to the support plate 19, and the support plate 19 vibrates in its racial direction, and further the blade 12 fixed to the support plate 19 vibrates in its radial direction. The cutting edge of the vibrating blade 12 is brought into contact with an article to be processed, while the blade 12 rotates, whereby the article is cut or grooved.

In the cutting machine 30 shown in FIG. 3, the cutting tool 10 is held by the holding means 33 attached to the rotating shaft 32 of the motor 31 by holding the support plate 14 in an area inner than the ultrasonic wave reflecting face 16.

Therefore, most of the ultrasonic vibration generated in the ultrasonic vibrator 14 and transmitted through the support plate 19 is reflected on the ultrasonic wave reflecting face 16 and utilized to efficiently vibrate the cutting edge of the blade 12 in the radial direction.

The blade 12 is fixed to the support plates 19, 19 by firmly screwing a pair of the protruded ring 34a, 35a with the nut 38.

In the cutting tool of the invention, the cutting blade is preferably fixed to the support plates using an adhesive. The blade and support plates united with an adhesive vibrates simultaneously.

The adhesive preferably is a hot melt adhesive. The blade can be easily separated from the support plates by heating the adhesive if the they are united using the hot melt adhesive. For example, when the blade is worn, the blade can be removed from the support plates. Therefore, the support plates equipped with the expensive ultrasonic vibrator can be re-used with a newly set blade.

FIG. 4 is a sectional view of another example of the cutting tool according to the invention.

The cutting tool 40 shown in FIG. 4 is the same as that of FIGS. 1 and 2, except that the ultrasonic wave reflecting face 46 formed by the interface of the circular vacant space (that is, the vacant space comprising four arcuate openings 45, 45, - - - which are formed in the support plate 49 via non-vacant area) is arranged in an area inner than the inner periphery of the ultrasonic vibrator 14.

As is seen from FIG. 4, the ultrasonic wave reflecting face can be placed in an area inner than the inner periphery of the ultrasonic vibrator 14 as is shown in FIGS. 1 and 2 or in an area outer than the inner periphery of the ultrasonic vibrator 14 as is shown in FIG. 4. However, the ultrasonic wave reflecting face 46 should be placed in an area inner than the ultrasonic vibrator 14 so as to the ultrasonic vibration is applied to an area outer than the ultrasonic reflecting face 46.

Even when the ultrasonic reflecting face 46 is placed in an area outer than the inner periphery of the ultrasonic vibrator 14, most of the ultrasonic vibration applied to the support place 49 is reflected on the ultrasonic wave reflecting face 46 and returned toward the outer periphery of the blade 12. Therefore, the ultrasonic vibration is scarcely transmitted to the rotating shaft holding the support plate 49.

Therefore, the blade 12 can be vibrate in the radial direction in ultrasonic mode with an enlarged amplitude.

FIG. 5 is a top view of a further example of the cutting tool according to the invention, and FIG. 6 is a sectional view of the cutting tool 50, taken along the line II-II shown in FIG. 5.

The cutting tool 50 is the same as that shown in FIGS. 1 and 2 except that an additional ultrasonic wave reflecting face 56 is provided to the support plate 59 in an area inner than the non-vacant area 18. The additional ultrasonic wave reflecting face 56 is provided by forming the additional arcuate vacant space (in the arcuate opening 55).

Thus, the support plate 59 of the cutting tool 50 is provided with the ultrasonic wave reflecting face 16 consisting of plural reflecting faces 17, 17, 17, 17 which correspond to the interfaces provided by the arcuate vacant spaces (in the arcuate opening 15) and the additional ultrasonic wave reflecting face 56 consisting of plural reflecting faces 57, 57, 57, 57 which correspond to the interfaces provided by the arcuate vacant spaces (in the arcuate opening 55).

The each reflecting face 57 of the additional ultrasonic wave reflecting face 56 serves to reflect the ultrasonic wave having been transmitted through the non-vacant bridging area 18 between the reflecting faces 17, 17 to return the ultrasonic wave toward the outer periphery of the support plate 59. Therefore, transmission of the ultrasonic wave to the inner area of the support plate 59 and to the rotating shaft is more effectively inhibited.

The cutting tool 50 is provide with the ultrasonic wave reflecting face 16 and additional ultrasonic wave reflecting face 56 wholly in the circular direction. Therefore, the ultrasonic vibration generated in the ultrasonic vibrator 14 can be more efficiently utilized to vibrate the periphery of the support plate 59.

Accordingly, the cutting edge of the blade 12 of the cutting tool 50 vibrates in the radial direction with a more enlarged amplitude, and hence the cutting precision is improved.

FIG. 7 is a top view of a still further example of the cutting tool according to the invention.

The cutting tool 70 shown in FIG. 7 is the same as the cutting tool 10 shown in FIGS. 1 and 2, except that the circular vacant space is formed of plural circular vacant spaces (in the circular opening 75) which are connected to each other via non-vacant area 78. The ultrasonic wave reflecting face 76 of the support plate 79 of the cutting tool 70 comprises plural reflecting face 77, 77, - - - which correspond to the interfaces formed by the plural circular vacant areas (in the circular opening 75).

Thus, the circular vacant space of the cutting tool of the invention can be formed of plural circular (or elliptic) or polygonal (preferably trigonal to octagonal) vacant space connected to each other via non-vacant bridging space 78.

FIG. 8 is a top view of a still further example of the cutting tool according to the invention.

The cutting tool 80 of FIG. 8 is the same as the cutting tool 10 shown in FIGS. 1 and 2 except that the circular vacant space comprises plural hexagonal vacant spaces (in the hexagonal opening 85) formed in the support plate 89 and connected to each other via non-vacant bridging space 88, and an additional vacant hexagonal vacant space (in the hexagonal opening 85a) in the support plate 89 and connected to each other via non-vacant bridging space.

The support plate 89 of the cutting tool 80 has an ultrasonic wave reflecting face 86 comprising plural reflecting faces 87, 87, - - - , which are formed by the provision of the hexagonal space areas (in the hexagonal opening 85) and an additional ultrasonic wave reflecting face 86a in the inner area which comprises plural reflecting faces 87a, 87a, - - - , which are formed by the provision of the hexagonal space areas (in the hexagonal opening 85a).

The support plate 89 has the inner area and outer area which are connected with a honeycomb structure formed of plural hexagonal openings 85, 85, - - - and plural hexagonal openings 85a, 85a, - - - , and hence the mechanical strength of the support plate is high.

FIG. 9 is a top view of a still further example of the cutting tool according to the invention.

The cutting tool 90 of FIG. 9 is the same as the cutting tool 10 shown in FIGS. 1 and 2, except that the circular vacant space comprises plural vacant slits (in the slitlike opening 95) connected sequentially via non-vacant areas 98, in which the vacant spaces is formed around an center axis of the support 99, slanting to a radial direction of the support 99, and extending in a thickness direction of the support 99.

The ultrasonic wave reflecting face 96 of the support 99 of the cutting tool 90 consists of plural reflecting faces 97, 97, - - - , which correspond to the interfaces provided by the plural vacant slits (in the slit opening 95).

FIG. 10 is a top view of a still further example of the cutting tool according to the invention, and FIG. 11 is a sectional view of the cutting tool 100, taken along the line shown in FIG. 10.

The cutting tool 100 shown in FIGS. 10 and 11 are the same as the cutting tool 10 shown in FIGS. 1 and 2, except that the circular vacant space in the support plate 109 is composed of circular porous material, that the support 109 extends to an area inner than the periphery of the circular opening 11 of the blade 12, and further that the support plate 109 is fixed to the cutting blade 12 by screwing the nut 108.

The support plate 109 of the cutting tool 100 can be manufactured by placing a porous material 109c in the form of a ring between the inner area portion 109a and outer area portion 109b and combining them by welding (or using an adhesive). Thus, the support plate 109 of the cutting tool 100 has an ultrasonic wave reflecting face 106 comprising plural reflecting faces 107, 107, - - - , provided by the porous portions 105, 105, - - - in the circular porous material 109c. The porous material can be metallic porous material which is employable as a sound-absorbing material or a heat-shielding material. The circular porous material 109c can be sintering a compressed metallic powder or fibers made of bronze, stainless steel, nickel or titanium. The pores of the porous material generally has a pore size in the range of 10 nm to several mm, depending on the process for producing the porous material.

The circular porous material 109c preferably has a density of 5 to 75% of the density of the support plate 109 in the outer area 109b.

If the support plate 109 extends to the area inner than the periphery of the circular opening 11 of the blade 12, the ultrasonic vibration transmitted to the plate 109 from the blade 12 can be reflected on the ultrasonic wave reflecting face 106 and returned to the outer periphery of the blade 12.

Therefore, the support plate 109 of the cutting tool 100 can be vibrate in its radial direction with an enlarged amplitude.

The support plate 109 of the cutting tool 100 has no opening traversing from one surface to another surface. Therefore, the rotation of the cutting tool is almost free from noise produced by the contact of the opening with air even when the cutting tool is rotated at an extremely high speed. In this connection, a porous material such as porous resinous material (e.g., porous polyurethane resin) can be placed in the arcuate openings 15 of the support plate 19 of the cutting tool 10 in FIG. 1, so as to refrain from production of noise by the contact of the opening with air.

FIG. 12 is a top view of a still further example of the cutting tool according to the invention, and FIG. 13 is a sectional view of the cutting tool 120, taken along the line IV-IV shown in FIG. 12.

The cutting tool 120 shown in FIGS. 12 and 13 is the same as the cutting tool 10 of FIGS. 1 and 2, except that the ultrasonic wave reflecting face 126 is provided by circular groove 125 extended from one surface in the thickness direction. The groove can be extended from another surface, that is, the surface in contact with the blade.

The circular groove preferably has a depth in the range of ¼ to ¾, more preferably ½ to ¾, based on the thickness of the support plate.

The groove can be continuous or discontinuous.

FIG. 14 is a sectional view of a still further example of the cutting tool according to the invention.

The cutting tool 140 of FIG. 14 is the same as the cutting tool 100 shown in FIGS. 10 and 11, except that the circular groove is in the form of a combination of a circular groove 145a (which gives an ultrasonic wave reflecting face 146a) extended from one surface of the support plate and an additional circular groove 145b (which gives an additional ultrasonic wave reflecting face 146b) formed on the inner area and extended from another surface. The grooves in the cutting tool 140 have a depth exceeding ½ of the thickness of the support plate.

The cutting tool 140 has a couple of the ultrasonic wave reflecting faces 146a, 146b in the whole circular area. Further, the two reflecting faces gives in combination a reflecting face formed from one surface to another surface. Accordingly, the transmission of the ultrasonic vibration produced in the outer area of the support plate to the inner area is inhibited more efficiently.

FIG. 15 is a sectional view of a still further example of the cutting tool according to the invention.

The cutting tool 150 of FIG. 15 is the same as the cutting tool 10 shown in FIGS. 1 and 2, except that the area 155 in the vicinity of the inner periphery of the support plate 159 is made thinner to give an ultrasonic wave reflecting face 156.

FIG. 16 is a sectional view of a still further example of the cutting tool according to the invention.

The cutting tool 160 of FIG. 16 is the same as the cutting tool 140 of FIG. 14, except that the support plate 169 has a pair of ultrasonic vibrators 14 on each surface, that a combination of a groove 165a extending from one surface to a thickness direction for forming an ultrasonic wave reflecting face 166a and a groove 165b extending from another surface to a thickness direction for forming an ultrasonic wave reflecting face 166b are formed in the support plate 169, and that a sleeve 169a for attaching a cutting tool 160 to a rotating shaft is united to the support plate 169 at its inner periphery.

FIG. 17 is a top view of a still further example of the cutting tool according to the invention, and FIG. 18 is a sectional view of the cutting tool 170, taken along the line V-V shown in FIG. 17.

The cutting tool 170 of FIG. 17 is the same as the cutting tool 50 shown in FIGS. 5 and 6, except that the ultrasonic vibrator 174 comprises plural ultrasonic vibrator pieces 174a, 174a, - - - , arranged sequentially via a space and a vacant space (in the slit 175) is formed in the support plate 179 under the former space. The ultrasonic vibrator piece can be a circular or polygonal piece.

The vacant space formed in the slit 175 between the adjacent vibrator pieces is effective to keep from generation of vibration transmitting in a direction other than the radial direction and hence to keep the support plate from in-plane flexural vibration.

FIG. 19 is a top view of a still further example of the cutting tool according to the invention, and FIG. 20 is a sectional view of the cutting tool 190, taken along the line VI-VI shown in FIG. 19.

The cutting tool 190 of FIGS. 19 and 20 comprises a support plate 199 in which a circular notch 165a giving an ultrasonic wave reflecting face 166a, an additional circular notch 165b giving an additional ultrasonic wave reflecting face 166b, a combination of arcuate openings 15, 15, 15, 15 giving a further additional ultrasonic wave reflecting face 16, and a combination of arcuate openings 55, 55, 55, 55 giving a further additional ultrasonic wave reflecting face 56.

FIG. 21 is a top view of a still further example of the cutting tool according to the invention, and FIG. 22 is a sectional view of the cutting tool 210, taken along the line VII-VII shown in FIG. 21.

The cutting tool 210 of FIGS. 21 and 22 comprises a support plate 219 in which a circular notch 165a giving an ultrasonic wave reflecting face 166a, an additional circular notch 165b giving an additional ultrasonic wave reflecting face 166b, a combination of plural circular holes 215a, 215a, - - - giving a further additional ultrasonic wave reflecting face 216a, and a combination of plural circular holes 215b, 215b, - - - giving a further additional ultrasonic wave reflecting face 216b.

FIG. 23 is a top view of a still further example of the cutting tool according to the invention, and FIG. 24 is a sectional view of the cutting tool 230, taken along the line VIII-VIII shown in FIG. 23.

The cutting tool 230 shown in FIGS. 13 and 14 is the same as the cutting tool 10 shown in FIGS. 1 and 2, except that each ultrasonic vibrator 14 is fixed to the blade 12 in an area outer than the inner periphery of the plate 19 and outer than the outer periphery of the plate 19.

In the cutting tool 230, ultrasonic vibration generated in the ultrasonic vibrator 14 fixed onto the blade 12 is transmitted to the support plate 19 through the blade 12. The ultrasonic vibration transmitted to the plate 19 is reflected on the ultrasonic wave reflecting face 16 and transmitted to the outer periphery of the plate 19 and is not transmitted to the area inner than the reflecting face 16.

FIG. 25 is a top view of a still further example of the cutting tool according to the invention, and FIG. 26 is a sectional view of the cutting tool 250, taken along the line IX-IX shown in FIG. 25.

The cutting tool 250 shown in FIGS. 25 and 26 is the same as the cutting tool 10 shown in FIGS. 1 and 2, except that the ultrasonic vibrator 14 is fixed to a surface of the blade 12 on the side having no support plate, in an area outer than the inner periphery of the support plate 19.

In the cutting tool 250, ultrasonic vibration generated in the ultrasonic vibrator 14 fixed onto the blade 12 is transmitted to the support plate 19 through the blade 12. The ultrasonic vibration transmitted to the plate 19 is reflected on the ultrasonic wave reflecting face 16 and transmitted to the outer periphery of the plate 19 and is not transmitted to the area inner than the reflecting face 16.

The cutting tool according to the aforementioned second invention and the cutting machine equipped with the cutting tool is described below, with reference to the attached drawings.

FIG. 27 is a top view of a still further example of the cutting tool according to the invention, and FIG. 28 is a sectional view of the cutting tool 270, taken along the line IX-IX shown in FIG. 27.

The cutting tool 270 shown in FIGS. 27 and 28 comprises a cutting disc blade 12 having a circular hole 11 at a center thereof, a pair of support ring plates 279, 279 coaxially arranged in parallel to the blade 12 with spaces, said support ring plates each having a protruded ring 279a which holds the blade 12 between in an area inner than an outer periphery of the blade, and an ultrasonic vibrator 14 in the form of a continuous or discontinuous ring, the ultrasonic vibrator 14 being coaxially fixed onto a surface of the support plate 279 in an area outer than an inner periphery of the support plate 279 or onto a surface of the blade in an area outer than the protruded ring of the support plate, wherein the support plate 279 has an ultrasonic wave reflecting face 16 (in the arcuate openings 15, 15, 15, 15 formed in the support plate 279) extending in a thickness direction thereof, said reflecting face 16 being an interface formed between the support plate and a continuous or discontinuous circular vacant space formed on the support plate in an area inner than an inner periphery of the ultrasonic vibrator 14.

The cutting tool 270 shown in FIGS. 27 and 28 is the same as the cutting tool 10 shown in FIGS. 1 and 2, except that each support plate 279 has a protruded ring (protrusion in the form of a ring) 279a on the side of the blade 12 and hence is arranged in parallel to the blade 12 via the protruded ring 279a with a space, that one support plate 279 (the right plate in FIG. 28) is equipped with a sleeve 169a in an inner area (the sleeve 169a serves for attaching the cutting tool 270 to a rotating shaft), and that the blade 12 is fixed between the support plates 279, 279 by screwing the nut 38.

The ultrasonic vibration generated in the ultrasonic vibrator 14 is transmitted to the support plate 279 and reflected on the ultrasonic wave reflecting face 16 to return toward the outer periphery of the support plate 279.

FIG. 29 is a sectional view of a cutting machine of the invention which is equipped with the cutting tool 270 shown in FIGS. 27 and 28.

The cutting machine 290 of FIG. 29 comprises:

a cutting disc tool 270 comprising a cutting disc blade 12 having a circular hole 11 at a center thereof, a pair of support ring plates 279, 279 coaxially arranged in parallel to the blade 12 with spaces, said support ring plates each having a protruded ring 279a which holds the blade 12 between in an area inner than an outer periphery of the blade, and an ultrasonic vibrator 14 in the form of a continuous or discontinuous ring, the ultrasonic vibrator 14 being coaxially fixed onto a surface of the support plate 279 in an area outer than an inner periphery of the support plate 279 or onto a surface of the blade in an area outer than the protruded ring 279a of the support plate 279, wherein the support plate 279 has an ultrasonic wave reflecting face 16 extending in a thickness direction thereof, said reflecting face 16 being interface formed between the support plate and a discontinuous circular vacant space formed on the support plate in an area inner than an inner periphery of the ultrasonic vibrator, and

a rotating shaft 32 holding the cutting disc tool 270 in a position inner than the ultrasonic wave reflecting face 16 of the support plate 279.

The cutting machine 290 of FIG. 29 is the same as the cutting machine 30 of FIG. 3, except that the cutting tool 270 of the second invention which is shown in FIGS. 27 and 28 is held to the rotating shaft 32 by screwing a bolt 37.

FIG. 30 is a sectional view of a still further example of the cutting tool according to the invention.

The cutting tool 300 of FIG. 30 is the same as the cutting tool 270 shown in FIGS. 27 and 28, except that each ultrasonic vibrator 14 is fixed onto the support plate 12 on the side facing the blade 12 and in the area outer than the inner periphery of the support plate 279.

In the cutting tool according to the second invention, the ultrasonic vibrator can be attached to the support plate on the blade side, because the support plate is arranged apart from the blade.

FIG. 31 is a sectional view of a still further example of the cutting tool according to the invention.

The cutting tool 310 of FIG. 31 is the same as the cutting tool 270 shown in FIGS. 27 and 28, except that each ultrasonic vibrator 14 is fixed onto the blade 12 in the area outer than the support plate 279.

In the cutting tools according to the first and second invention, the ultrasonic wave reflecting face is preferably formed under such condition that the circular reflecting face is formed in an area of 50 to 100%, more preferably 70 to 90%, or 90 to 100%, of the circle. Particularly, the ultrasonic wave reflecting face is formed from one surface to another surface to give a complete circle, as is seen in FIGS. 5, 8, 9, 14, 17 and 19.

### BRIEF DESCRIPTION OF THE DRAWINGS

FIG. 1 is a top view of an example of the cutting tool according to the invention.

FIG. 2 is a sectional view of the cutting tool 10, taken along the line I-I shown in FIG. 1.

FIG. 3 is a sectional view of an example of the cutting machine according to the invention.

FIG. 4 is a sectional view of another example of the cutting tool according to the invention.

FIG. 5 is a top view of a further example of the cutting tool according to the invention.

FIG. 6 is a sectional view of the cutting tool 50, taken along the line II-II shown in FIG. 5.

FIG. 7 is a top view of a still further example of the cutting tool according to the invention.

FIG. 8 is a top view of a still further example of the cutting tool according to the invention.

FIG. 9 is a top view of a still further example of the cutting tool according to the invention.

FIG. 10 is a top view of a still further example of the cutting tool according to the invention.

FIG. 11 is a sectional view of the cutting tool 100, taken along the line III-III shown in FIG. 10.

FIG. 12 is a top view of a still further example of the cutting tool according to the invention.

FIG. 13 is a sectional view of the cutting tool 120, taken along the line IV-IV shown in FIG. 12.

FIG. 14 is a sectional view of a still further example of the cutting tool according to the invention.

FIG. 15 is a sectional view of a still further example of the cutting tool according to the invention.

FIG. 16 is a sectional view of a still further example of the cutting tool according to the invention.

FIG. 17 is a top view of a still further example of the cutting tool according to the invention.

FIG. 18 is a sectional view of the cutting tool 170, taken along the line V-V shown in FIG. 17.

FIG. 19 is a top view of a still further example of the cutting tool according to the invention.

FIG. 20 is a sectional view of the cutting tool 190, taken along the line VI-VI shown in FIG. 19.

FIG. 21 is a top view of a still further example of the cutting tool according to the invention.

FIG. 22 is a sectional view of the cutting tool 210, taken along the line VII-VII shown in FIG. 21.

FIG. 23 is a top view of a still further example of the cutting tool according to the invention.

FIG. 24 is a sectional view of the cutting tool 230, taken along the line VIII-VIII shown in FIG. 23.

FIG. 25 is a top view of a still further example of the cutting tool according to the invention.

FIG. 26 is a sectional view of the cutting tool 250, taken along the line IX-IX shown in FIG. 25.

FIG. 27 is a top view of a still further example of the cutting tool according to the invention.

FIG. 28 is a sectional view of the cutting tool 270, taken along the line IX-IX shown in FIG. 27.

FIG. 29 is a sectional view of another example of the cutting machine according to the invention.

FIG. 30 is a sectional view of a still further example of the cutting tool according to the invention.

FIG. 31 is a sectional view of a still further example of the cutting tool according to the invention.

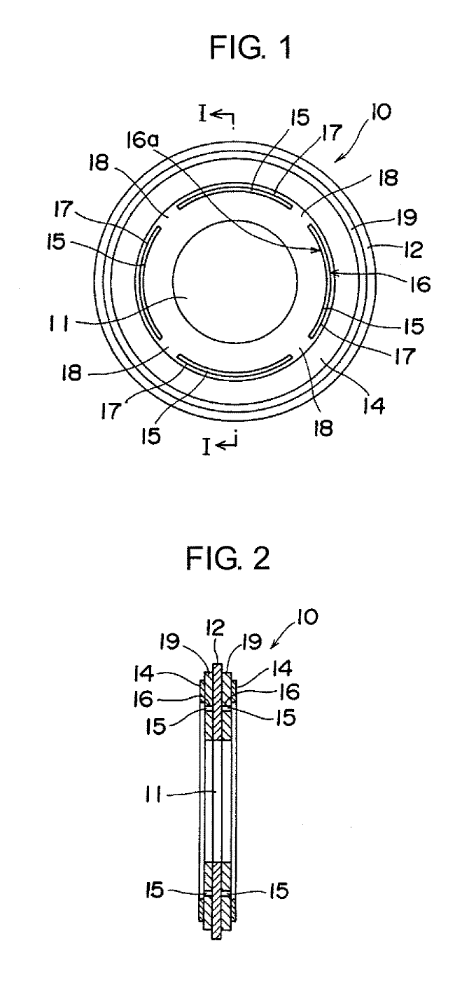

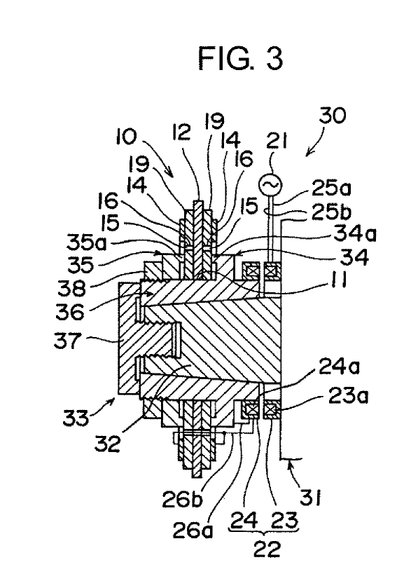

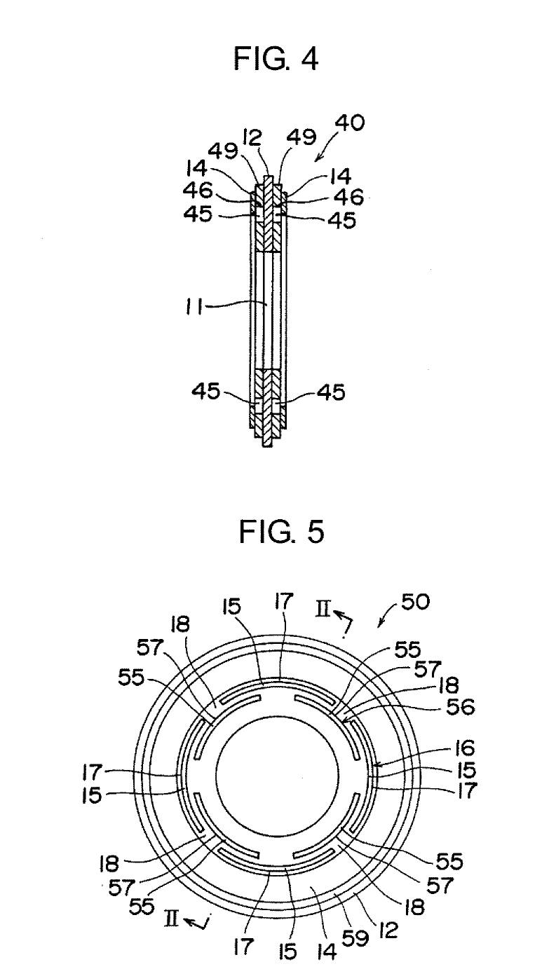

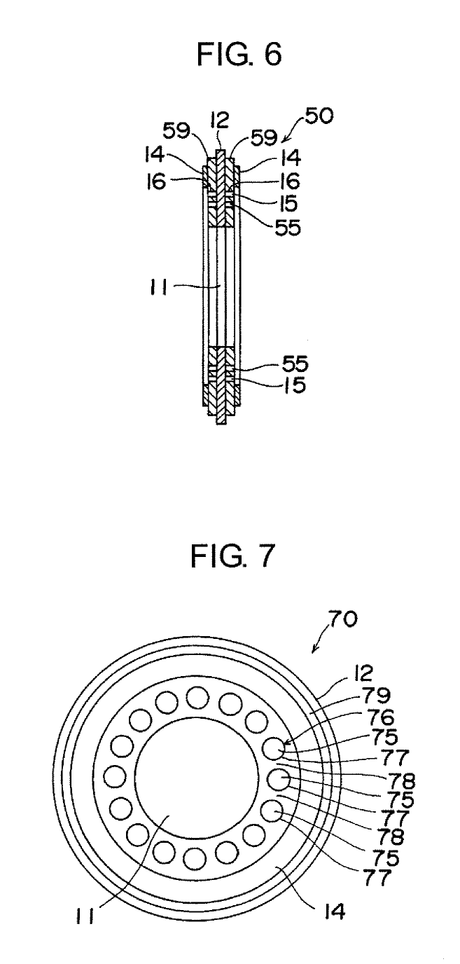

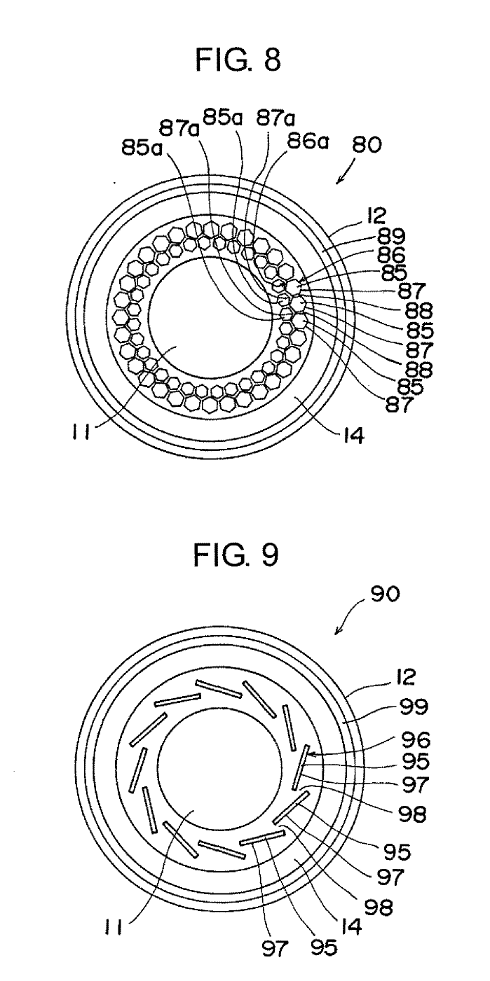

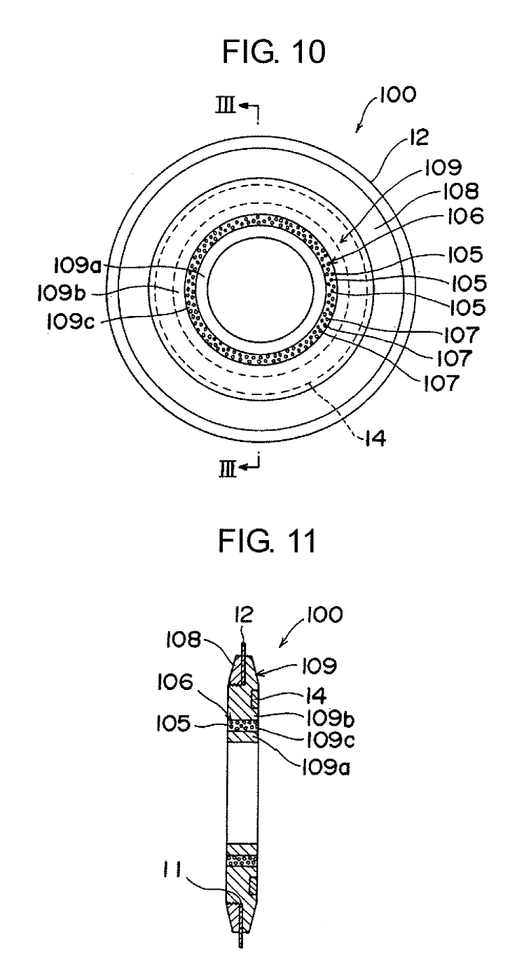

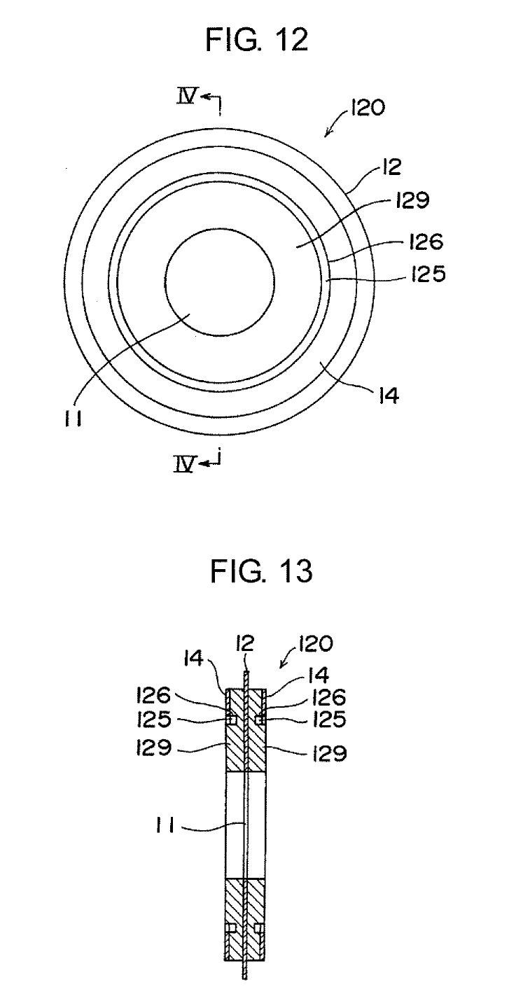

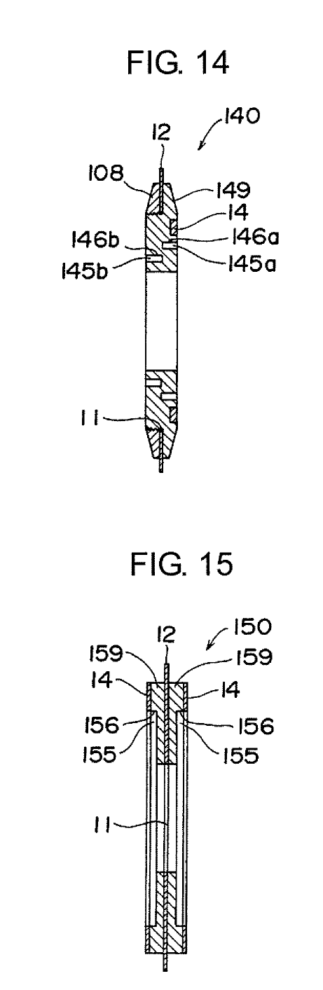

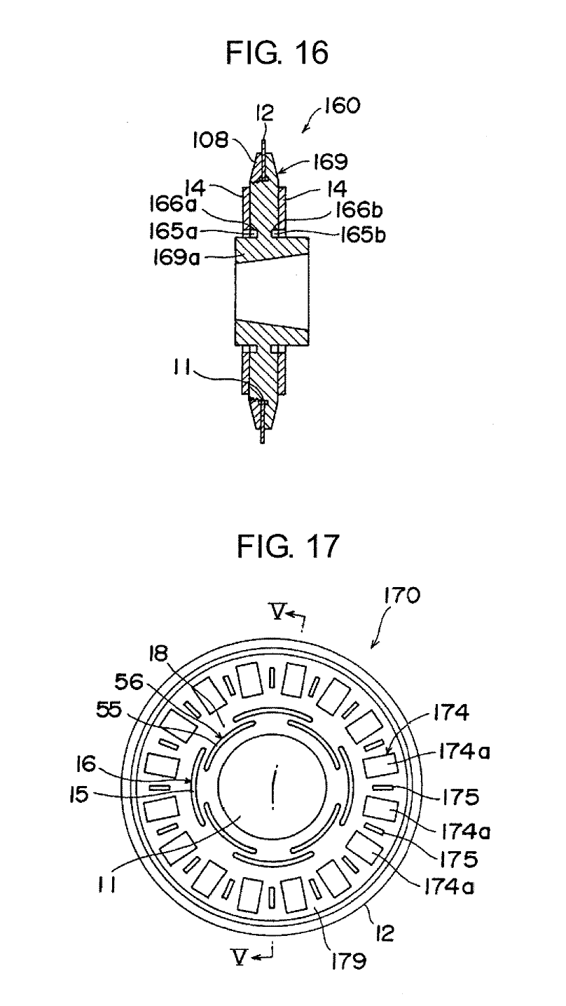

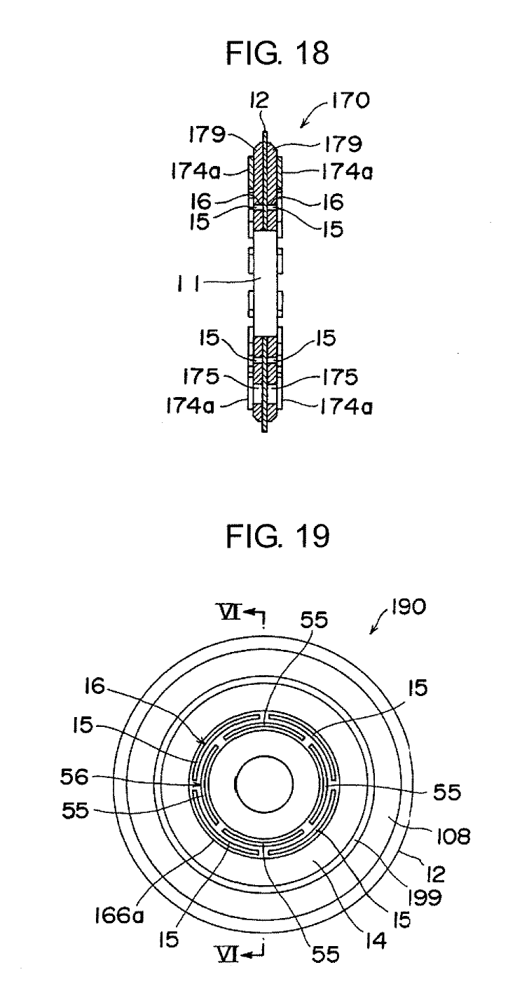

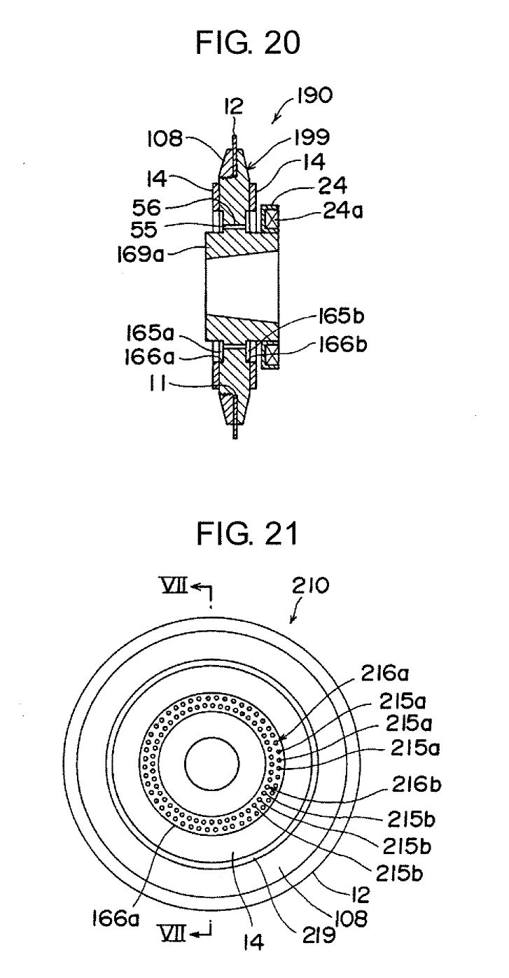

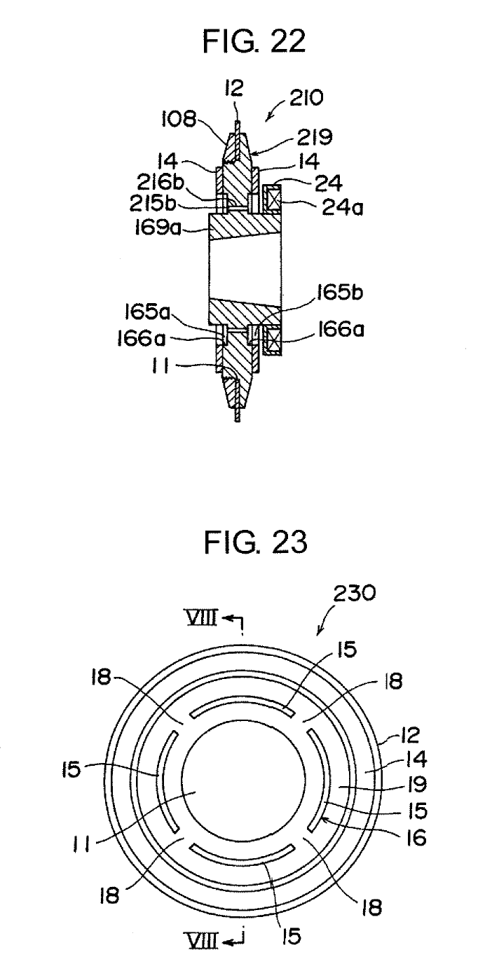

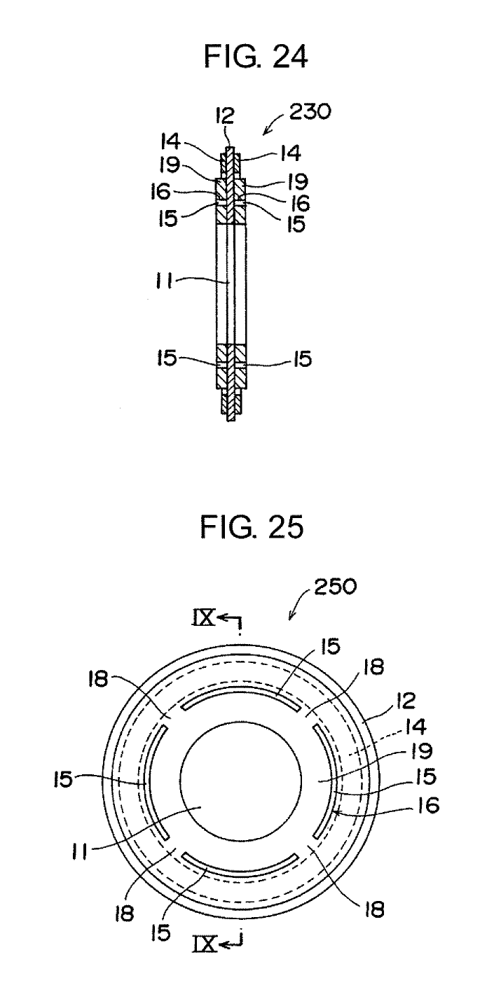

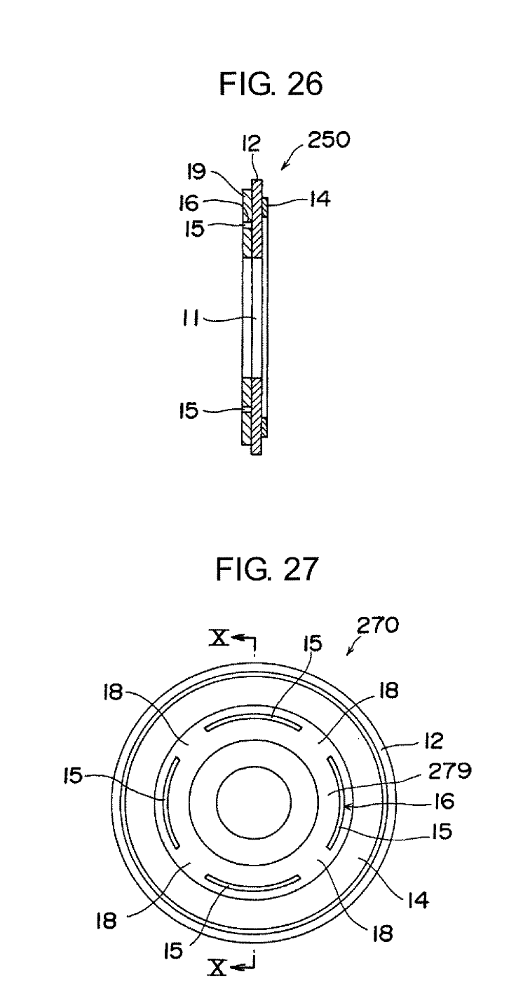

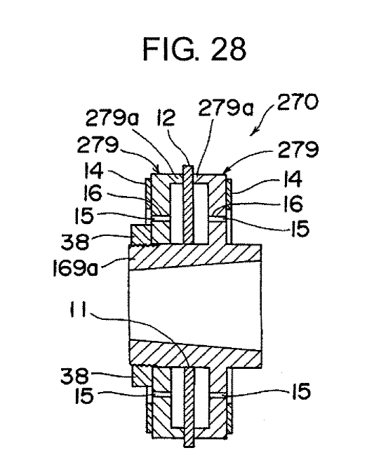

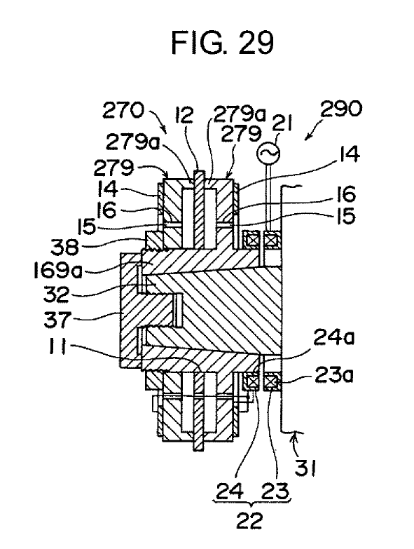

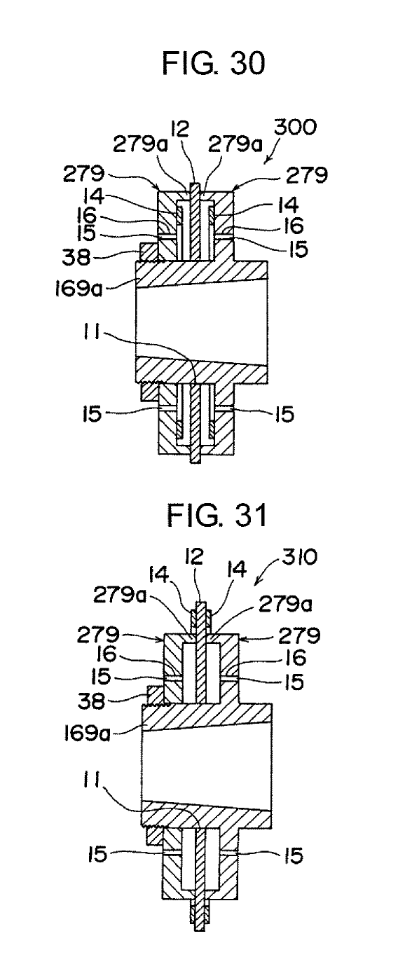

The reference numerals mean the following:

10 cutting tool, 11 hole, 12 cutting blade, 14 ultrasonic vibrator, 15 arcuate vacant space, 16 ultrasonic wave reflecting face, 16a interface with the vacant space, 17 reflecting face forming ultrasonic wave reflecting face 16, 18 non-vacant area, 19 support plate, 21 power source, 22 rotary transformer, 23 power supply unit, 24 power receiving unit, 23a, 24a coil, 25a, 25b wiring, 26a, 26b wiring, 30 cutting machine, 31 motor, 32 rotating shaft, 33 holding means, 34, 35 flange, 34a, 35a protrusion, 36 sleeve, 37 bolt, 38 nut, 40, 50 cutting tool, 45, 55 arcuate opening, 46, 56 ultrasonic wave reflecting face, 49, 59 support plate, 57 reflecting face forming ultrasonic wave reflecting face 56, 70, 80, 90 cutting tool, 75 circular hole, 76, 86, 86a, 96 ultrasonic wave reflecting face, 77, 87, 87a, 97 reflecting face forming ultrasonic wave reflecting face, 78, 88, 98 non-vacant space, 79, 89, 99 support plate, 85, 85a hexagonal hole, 95 slit, 100 cutting tool, 105 babble, 106 ultrasonic wave reflecting face, 107 reflecting face forming ultrasonic wave reflecting face 106, 108 nut, 109 support plate, 109a inner side area of support plate 109, 109b outer side area of the support plate 109, 109c porous material in the form of a ring, 120, 140 cutting tool, 125, 145a, 145b groove in the form of a ring, 126, 146a, 146b ultrasonic wave reflecting face, 129, 149 support plate, 150, 160 cutting tool, 155, 165a, 165b notch in the form of a ring, 156, 166a, 166b ultrasonic wave reflecting face, 159, 169 support plate, 169a sleeve, 170 cutting tool, 174 ultrasonic vibrator, 174a ultrasonic vibrator piece, 175 slit, 179 support plate, 190, 210 cutting tool, 199, 219 support plate, 215a, 215b circular hole, 216a, 216b ultrasonic wave reflecting face, 230, 250 cutting tool, 270, 300, 310 cutting tool, 279 support plate, 279a protrusion on support plate, 290 cutting machine

1. A cutting disc tool comprising a cutting disc blade having a circular hole at a center thereof, a support ring plate coaxially fixed onto at least one surface of the blade in an area inner than an outer periphery of the blade, and an ultrasonic vibrator in the form of a continuous or discontinuous ring, the ultrasonic vibrator being coaxially fixed onto a surface of the support plate or a surface of the blade in an area outer than an inner periphery of the support plate, wherein the support plate has an ultrasonic wave reflecting face extending in a thickness direction thereof, said reflecting face being an interface formed between the support plate and a continuous or discontinuous circular vacant space formed on the support plate in an area inner than an inner periphery of the ultrasonic vibrator.

2. The cutting disc tool of claim 1, wherein the circular vacant space comprises plural arcuate vacant spaces connected sequentially via a non-vacant area, said vacant spaces being formed coaxially on the support plate and extending in a thickness direction of the support.

3. The cutting disc tool of claim 2, wherein other arcuate vacant spaces are formed on the support along the non-vacant area on an inner periphery side of the support plate, said vacant spaces extending a thickness direction of the support plate, whereby forming an additional ultrasonic wave reflecting face.

4. The cutting disc tool of claim 1, wherein the circular vacant space comprises plural circular or polygonal vacant spaces connected sequentially via a non-vacant area, said vacant spaces being formed coaxially on the support plate and extending in a thickness direction of the support.

5. The cutting disc tool of claim 4, wherein other circular or polygonal vacant spaces are formed on the support along the non-vacant areas on an inner periphery side of the support plate, said vacant spaces extending a thickness direction of the support plate, whereby forming an additional ultrasonic wave reflecting face.

6. The cutting disc tool of claim 1, wherein the circular vacant space comprises plural vacant slits connected sequentially via non-vacant areas, said vacant slits being formed around an center axis of the support plate, slanting to a radial direction of the support plate, and extending in a thickness direction of the support.

7. The cutting disc tool of claim 1, wherein the circular vacant spaces are formed of circular porous material.

8. The cutting disc tool of claim 1, wherein the support has the ultrasonic wave reflecting face formed on a wall of a circular groove extending from one surface thereof exceeding a half of a thickness of the support plate and an additional ultrasonic wave reflecting face formed on a wall of a circular groove extending from another surface thereof exceeding a half of a thickness of the support plate.

9. The cutting disc tool of claim 1, wherein the ultrasonic vibrator comprises plural ultrasonic vibrator pieces arranged sequentially via a space and a vacant space is formed in the support plate under the former space.

10. A cutting machine comprising:
a cutting disc tool comprising a cutting disc blade having a circular hole at a center thereof, a support ring plate coaxially fixed onto at least one surface of the blade in an area inner than an outer periphery of the blade, and an ultrasonic vibrator in the form of a continuous or discontinuous ring, the ultrasonic vibrator being coaxially fixed onto a surface of the support plate or a surface of the blade in a area outer than an inner periphery of the support plate, wherein the support plate has an ultrasonic wave reflecting face extending in a thickness direction thereof, said reflecting face being interface formed between the support plate and a continuous or discontinuous circular vacant space formed on the support plate in an area inner than an inner periphery of the ultrasonic vibrator, and
a rotating shaft holding the cutting disc tool in a position inner than the ultrasonic wave reflecting face of the support plate.

11. A cutting disc tool comprising a cutting disc blade having a circular hole at a center thereof, a pair of support ring plates coaxially arranged in parallel to the blade with spaces, said support ring plates each having a protruded ring which holds the blade in an area inner than an outer periphery of the blade, and an ultrasonic vibrator in the form of a continuous or discontinuous ring, the ultrasonic vibrator being coaxially fixed onto a surface of the support plate in an area outer than an inner periphery of the support plate or onto a surface of the blade in an area outer than the protruded ring of the support plate, wherein the support plate has an ultrasonic wave reflecting face extending in a thickness direction thereof, said reflecting face being an interface formed between the support plate and a continuous or discontinuous circular vacant space formed on the support plate in an area inner than an inner periphery of the ultrasonic vibrator.

12. The cutting disc tool of claim 11, wherein the circular vacant space comprises plural arcuate vacant spaces connected sequentially via a non-vacant area, said vacant spaces being formed coaxially on the support plate and extending in a thickness direction of the support.

13. The cutting disc tool of claim 12, wherein other arcuate vacant spaces are formed on the support along the non-vacant area on an inner periphery side of the support plate, said vacant spaces extending a thickness direction of the support plate, whereby forming an additional ultrasonic wave reflecting face.

14. The cutting disc tool of claim 11, wherein the circular vacant space comprises plural circular or polygonal vacant spaces connected sequentially via a non-vacant area, said vacant spaces being formed coaxially on the support plate and extending in a thickness direction of the support.

15. The cutting disc tool of claim 14, wherein other circular or polygonal vacant spaces are formed on the support along the non-vacant areas on an inner periphery side of the support plate, said vacant spaces extending a thickness direction of the support plate, whereby forming an additional ultrasonic wave reflecting face.

16. The cutting disc tool of claim 11, wherein the circular vacant space comprises plural vacant slits connected sequentially via non-vacant areas, said vacant slits being formed around an center axis of the support plate, slanting to a radial direction of the support plate, and extending in a thickness direction of the support.

17. The cutting disc tool of claim 11, wherein the circular vacant space is formed of circular porous material.

18. The cutting disc tool of claim 11, wherein the support has the ultrasonic wave reflecting face formed on a wall of a circular groove extending from one surface thereof exceeding a half of a thickness of the support plate and an additional ultrasonic wave reflecting face formed on a wall of a circular groove extending from another surface thereof exceeding a half of a thickness of the support.

19. The cutting disc tool of claim 11, wherein the ultrasonic vibrator comprises plural ultrasonic vibrator pieces arranged sequentially via a space and a vacant space is formed in the support plate under the former space.

20. A cutting machine comprising:
a cutting disc tool comprising a cutting disc blade having a circular hole at a center thereof, a pair of support ring plates coaxially arranged in parallel to the blade with spaces, said support ring plates each having a protruded ring which holds the blade in an area inner than an outer periphery of the blade, and an ultrasonic vibrator in the form of a continuous or discontinuous ring, the ultrasonic vibrator being coaxially fixed onto a surface of the support plate in an area outer than an inner periphery of the support plate or onto a surface of the blade in an area outer than the protruded ring of the support plate, wherein the support plate has an ultrasonic wave reflecting face extending in a thickness direction thereof, said reflecting face being an interface formed between the support plate and a continuous or discontinuous circular vacant space formed on the support plate in an area inner than an inner periphery of the ultrasonic vibrator, and
a rotating shaft holding the cutting disc tool in a position inner than the ultrasonic wave reflecting face of the support plate.
